(19) United States
(12) Patent Application Publication
(10) Pub. No.: US 2009/0251060 A1
(43) Pub. Date: Oct. 8, 2009

(54) ELECTRONIC BALLAST SYSTEM WITH LAMP INTERFACE NETWORK

(75) Inventor: Christopher P. Henze, Lakeville, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: Nicollet Technologies Corporation, Minneapolis, MN (US)

(21) Appl. No.: 12/415,685

(22) Filed: Mar. 31, 2009

Related U.S. Application Data
(60) Provisional application No. 61/041,115, filed on Mar. 31, 2008.

(51) Int. Cl. H05B 41/14

(52) U.S. Cl. 315/246

(57) ABSTRACT

An electronic ballast is provided, which includes first and second output nodes, first and second lamp outputs, and a lamp interface network. The lamp interface network includes an LC circuit coupled between at least one of the first and second output nodes and a respective one of the first and second lamp outputs.

### CROSS-REFERENCE TO RELATED APPLICATION

This application claims priority from and the benefit of U.S. Provisional Application No. 61/041,115, filed Mar. 31, 2008 and entitled ELECTRONIC BALLAST WITH LAMP INTERFACE NETWORK, the contents of which is hereby incorporated by reference in its entirety.

### FIELD OF THE DISCLOSURE

The present disclosure relates to control ballasts, and particularly, to electronic control ballasts for powering alternating current discharge loads, such as gas discharge lamps.

### BACKGROUND OF THE DISCLOSURE

Many applications call for the operation of alternating current (AC) discharge loads such as discharge lamps, including ultraviolet (UV) discharge lamps. For example, UV lamps are used for curing inks in printing systems. Many other uses for UV lamps are popular, representative examples of which include curing furniture varnish or heat-sensitive substrates, decontaminating food substances, sterilizing medical equipment or contact surfaces, optically pumping solid state lasers, electrically neutralizing surfaces, inducing skin tanning, and passing through fluorescent coatings to provide visible illumination. Additional uses for discharge lamps in other wavelengths are also popular, such as visible wavelength discharge lamps for providing illumination.

Gas discharge lamps are operated by power supplies commonly called ballasts. A ballast is necessary to operate a gas discharge lamp because the lamp appears as a constant voltage load. A constant voltage load cannot be controlled if it is connected to a constant voltage source such as the electric utility. An incandescent lamp appears as a simple resistive load and can be connected directly to the utility voltage.

Therefore, a lamp ballast allows a constant voltage load to be operated from a constant voltage source and provides control over current or power delivered to the lamp. High power discharge lamps typically must operate as an ac-device. These lamps will be damaged or destroyed if operated with in a dc-mode. This is true even if there is a small dc-component to the otherwise ac-voltage applied to a gas discharge lamp. The root mean square (rms) voltage at which a lamp operates is proportional on a first-order to the temperature of the gas inside the lamp. When a lamp starts to ignite, it will be cold and will operate at a very low voltage. As the gas heats up, the voltage will rise until steady-state operating conditions are obtained. Lamps are typically warmed-up with a constant ac-current.

Typically, lamps are used in industry with power ratings for several kilowatts to tens of kilowatts. Lamps often operate with a maximum current of 10 amps to 30 amps and operate at voltages in the range of 200 volts to 2000 volts.

A gas discharge lamp applies the operating voltage to the gas or vapor within the lamp. Several varieties of gas or vapor are used in gas discharge lamps. Mercury vapor is a popular choice; other gas discharge lamps are based on gallium, halogen, metal halide, xenon, sodium, or other varieties. The electricity ionizes the gas within the lamp, so that when electrons recombine with ions, light is emitted. This discharge light is alternately described as an arc, a glow, or a corona.

For a gas molecule to ionize, a minimum threshold electric field must be applied to it. A lesser field will only polarize gas molecules without causing ionization. So, an ignition voltage is typically required for a discharge lamp to achieve ionization of the gas molecules.

Once ionization begins, it initially drives a positive feedback chain reaction as the initially freed electrons collide with other polarized molecules close to the ionization energy and provide the extra energy needed to ionize. As the populations of ionized molecules and free electrons rise, the rate of recombination also rises, until an equilibrium is reached where the rate of new ionizations is equal to the rate of recombinations. A discharge load goes from the initial equilibrium with no current, through the unstable ignition transition with negative resistance, to the new operating equilibrium.

It is typically desirable to compensate for the negative resistance of the discharge load during the ignition transition, and to provide a lower voltage than the ignition voltage when the ionization equilibrium has been achieved. An enhanced level of current is often used for warm-up, while a lower run level of current is required to maintain normal operation.

Discharge lamps come in a wide range of sizes, and a correspondingly wide range of current, voltage, and power ratings. The voltage and power ratings on many lamps are considerably high.

The current, voltage, and power characteristics over time of the electrical supply must therefore be controlled within acceptable tolerances. The voltage provided to such lamps must also typically be in alternating current (AC) form. Allowing any net direct current through a discharge lamp often causes undesirable effects, such as gas migration and accumulation on the lamp electrodes, and saturation of the ballast.

Traditional ballasts are magnetic, which include end stage transformers placed in connection with the lamps, and banks of high-voltage capacitors. However, these traditional solutions have substantial drawbacks. For example, a traditional ballast may have only one set amount of power it can provide to its lamp, or at best only two or three options for power settings. For another example, a traditional ballast may have only a single voltage setting that is tailor-made for a specific lamp. This means a multi-lamp system will impose separate maintenance and replacement requirements for each of several different ballasts. As another example, traditional ballasts often provide a substantially inaccurate or variable current, with typical inaccuracy of up to 20% or more. As another example, traditional ballasts are often electrically inefficient and convert a significant fraction of current into waste heat, causing the ballasts to operate at high temperature, often leading to additional problems. As another example, traditional ballasts are often bulky, heavy, inconvenient, and expensive. To illustrate, a typical ultraviolet discharge lamp used for curing inks in a printing operation may be twelve feet long, and be supplied by a transformer ballast weighing 700 pounds. And a typical printing operation might have nine discharge lamps, each with a ballast rated for 15 kilowatts.

The inflexibility and inefficiency of power consumption in traditional ballasts therefore creates a demand for a substantial amount of input power. This problem is acute in multiple lamp systems, where the inflexible and inefficient demands of multiple lamps creates a substantial demand for the overall power. The greater the system demand for electrical power, the greater the initial capital costs and the ongoing maintenance and power costs.

Newer solutions are therefore desired for the problem of delivering electrical power to discharge lamp ballasts.

### SUMMARY

An aspect of the present disclosure relates to an electronic ballast, which includes first and second output nodes, first and second lamp outputs, and a lamp interface network. The lamp interface network includes an LC circuit coupled between at least one of the first and second output nodes and a respective one of the first and second lamp outputs.

Another aspect of the present disclosure relates to a circuit including an electronic ballast having an AC output with first and second output nodes. The circuit also includes first and second lamp outputs for connection to a gas discharge lamp and a lamp interface network having an inductance-capacitance (LC) circuit coupled between at least one of the first and second output nodes and a respective one of the first and second lamp outputs.

Another aspect of the present disclosure relates to a circuit including a ballast having an AC output with first and second output nodes. The circuit also includes first and second lamp outputs for connection to a gas discharge lamp and a lamp interface network. The lamp interface network includes a first inductor and a first resistor coupled in series with one another in a first leg between the first output node and the first lamp output, and a second inductor and a second resistor coupled in series with one another in a second leg between the second output node and the second lamp output. A capacitor is coupled between the first and second lamp outputs.

Another aspect of the present disclosure relates to a method including: generating, with a ballast, an alternating-current (AC) output voltage on first and second output nodes; and coupling the AC output to first and second gas discharge lamp outputs through an inductance-capacitance (LC) circuit and thereby limiting a rate of change of current on the first and second gas discharge lamp outputs.

Another aspect of the present disclosure relates to a method of interfacing an electronic ballast and an AC discharge load having a negative resistance.

### BRIEF DESCRIPTION OF THE DRAWINGS

FIG. 1 is a simplified schematic diagram of an electronic ballast control system according to an exemplary aspect of the present disclosure.

FIG. 2 is a waveform diagram illustrating idealized lamp voltage, current and power waveforms of the system shown in FIG. 1.

FIG. 3 is a schematic diagram illustrating a lamp interface network of the system shown in FIG. 1.

FIG. 4 illustrates a screen display from an oscilloscope showing waveforms produced by the circuit shown in FIGS. 1 and 3 when igniting a gas discharge lamp.

FIG. 5 shows the same waveforms as FIG. 4 when the lamp is running during normal operation.

### DETAILED DESCRIPTION OF ILLUSTRATIVE EMBODIMENTS

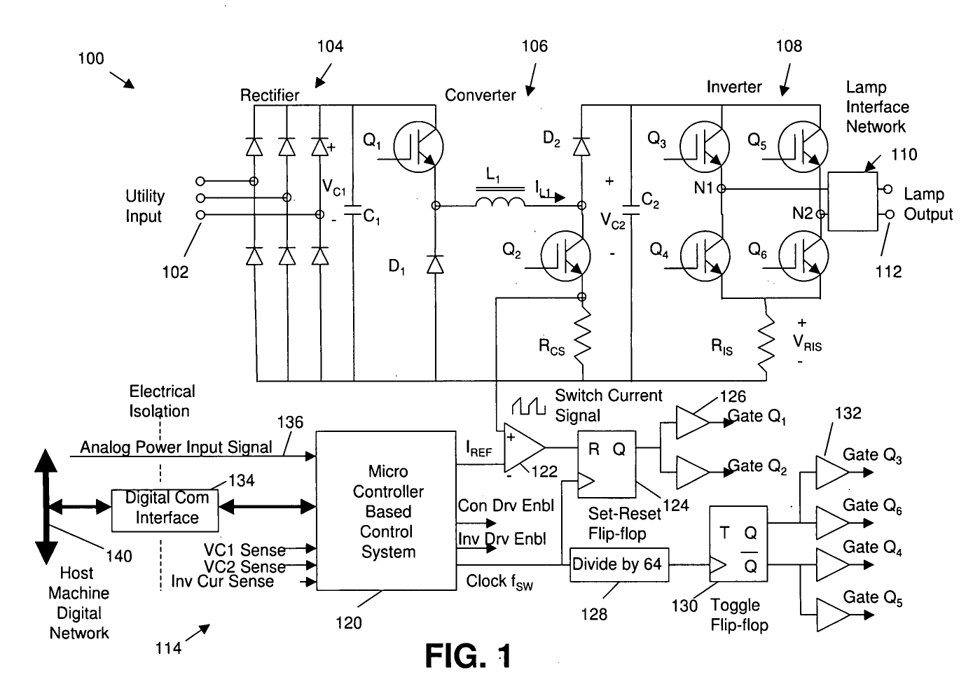

FIG. 1 is a simplified schematic diagram of an electronic ballast control system 100 according to an exemplary aspect of the present disclosure. System 100 includes a utility input 102, a rectifier 104, a DC-to-DC converter 106, an inverter 108, a lamp interface network 110, lamp outputs 112 and a control circuit 114

### 1. Basic Operation of the Electronic Ballast

For high power applications a three phase utility connection is used and applied to the utility input 102. In one example, the electronic ballast control system 100 shown in FIG. 1 can be designed to operate from nominal utility voltages ranging from 380 Vrms to 480 Vrms (line-to-line) at either 50 or 60 Hz. Other operating characteristics can also be used in other examples.

The utility voltage is converted to a dc-voltage by the rectifier diodes in rectifier 104 across dc-bus filter capacitor C1. An inductor can also be used between the output of the rectifier diodes and dc-bus filter capacitor C1 to improve the power factor. The voltage VC1 across capacitor C1 is the input to DC-to-DC converter 106.

Converter 106 includes transistors Q1 and Q2, diodes D1 and D2, inductor L1, converter-current sense resistor RCS, and output capacitor C2.

During normal operation, both switches Q1 and Q2 of the converter 106 are operated synchronously by control circuit 114. When they are turned on, the input voltage VC1 is applied to the inductor L1 and the current IL1 in the inductor L1 will increase linearly. When the switches are off, a path for the current IL1 in the inductor L1 must be maintained. This current will flow through diodes D1 and D2. The voltage across L1 will be equal to the negative of the voltage VC2 across the output capacitor C2. This will cause the current IL1 in the inductor L1 to decrease linearly during the “off time” of switches Q1 and Q2.

Through this “charge and dump” of inductor L1 the voltage at the output capacitor C2 can be regulated. If the duty cycle D is defined as the portion of the switching cycle that the switches Q1 and Q2 are conducting, then the output voltage is determined by the equation:

$${V}_{C 2} = {V}_{C 1} \frac{D}{1 - D}$$

Thus, the converter section operates as a step-up/step-down DC-to-DC converter, for example, as controlled by the duty cycle D. The above equation is true if the circuit is operating in steady state conditions, in continuous conduction mode and if the input and output capacitors are large enough so the ripple voltages across these components can be ignored. To be considered to be in continuous conduction, the inductor current may not be zero for any significant portion of the switching cycle

When insulated gate bipolar transistors (IBGTs) are used for switches Q1 and Q2, for example, which are capable of operating at power levels of tens of kilowatts, a typical switching frequency is in the range of about 5 to 15 kHz.

In one example, ballast control system 100 is configured to be used to drive a gas discharge lamp that requires an ac-voltage to operate. The lamp is connected across lamp outputs 112. The average voltage across the lamp over many cycles should be zero to avoid long-term damage to the lamp. The converter 106 can control the dc-power at its output. The inverter 108 is used to deliver this power to the lamp by applying a square wave voltage (and more correctly a square wave current) to the lamp. This is typically done at a lower frequency in the range from 50 to 500 Hz.

The inverter 108 includes transistors (or switches) Q3, Q4, Q5 and Q6 and inverter-current sense resistor RIS. The inverter transistors Q3-Q6 are controlled by control circuit 114, as discussed in more detail below. The square wave alternating current and voltage at lamp outputs 112 are produced by simultaneously turning on switches Q3 and Q6 (with Q4 and Q5 being off) for a time interval followed by an equal time interval (for example) during which switches Q4 and Q5 are turned on (with Q3 and Q6 being off). The arrangement of switches Q3 through Q6 is commonly called an “H-Bridge” and is used in power electronics for many applications such as this where an alternating or bipolar output voltage is needed across a load that is operated from a dc-source.

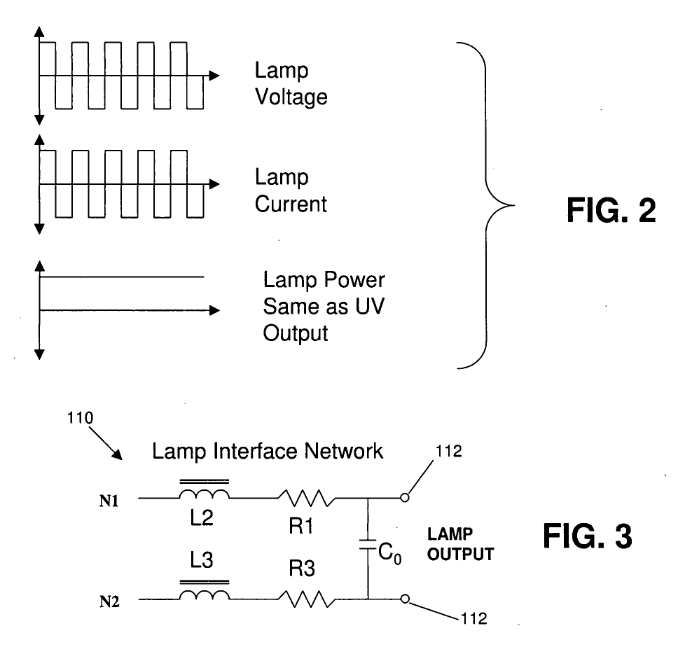

During normal, steady-state operation, the lamp (which is electrically connected across the lamp output terminals 112 in FIG. 1) acts as a constant voltage ac-load. To the first order, the voltage across the lamp is proportional to the lamp temperature. When the lamp temperature is low, the lamp voltage will be low. In steady state operation, assuming that voltage drops in the inverter switches can be neglected, the voltage VC2 across output capacitor C2 of the converter 106 will be equal to the magnitude of the square wave voltage across the lamp. Since there should not be any dc-current flow in capacitor C2 in steady state operation, the output dc-current from the converter 106 should equal to the magnitude of the current flowing though the lamp. If the output dc-current is controlled by the high frequency switching of the converter 106 (using current mode control for example) to be approximately constant over the low frequency switching cycle of the inverter 108, then the lamp current will have a square wave shape. This will produce a constant power discharge from the lamp. This is important to maintain a constant UV output from the lamp. The idealized lamp voltage, current and power waveforms are shown in FIG. 2.

### 2. Control Circuit 114

The electronic ballast is controlled by control circuit 114, which in the example shown in FIG. 1 includes a microcontroller-based control system 120, a comparator 122, a set-reset flip-flop 124, buffers 126, a divide-by-64 circuit 128 (for example), a toggle flip-flop 130, and buffers 132. The control circuit 114 can also include a digital communications interface 134 for receiving commands from or providing system status to one or more master controllers or other devices (not shown).

In one example, the customer or plant operator inputs a requested power to be delivered to the lamp, such as through the digital communications interface 134. Other control inputs can be provided such as an analog input signal 136 and/or other voltage states from DIP switches, etc. The control system 120 receives the requested power command and calculates the actual power by multiplying the instantaneous voltage and current being delivered to the lamp to determine the instantaneous power being delivered to the lamp. This value is low-pass filtered to determine an average power level, which is compared to the requested power from the customer input to determine a power-error value. In response, the control system 120 alters either continuously or intermittently the instantaneous current value at which the switches of the converter Q1 and Q2 are turned off to maintain a minimum power error under closed loop feedback control.

Various elements of the control system 114 shown in FIG. 1 are described below.

### 2.1 Host Machine Digital Network

Typically the machine in which the ballast or multiple ballasts are installed has a computer that functions as a master controller (not shown in FIG. 1). The master controller is in constant communication with the various subsystems of the machine. For example, a ballast may receive a signal to increase its output power while at nearly the same time, a motor drive connected to a shutter may be given a command to open the shutter. These conditions will be maintained while a portion of the product being processed by the machine passes under the UV lamp, which the ballast is driving.

In industrial automation, several communication protocols can be used for sending commands and data from one part of the machine to another. Some commonly used communication protocols include EtherNet/IP, DeviceNet, ControlNet, and ProfiBus. There are standards and specifications that control the detailed operation of devices communicating on these networks.

The electronic ballast control system shown in FIG. 1 includes an option to implement one or more of these interfaces. The control system 114 will appear as a “node” that is ready to communicate with the host controller over host-machine digital network 140. In an alternative embodiment, an analog interface is used to control the ballast. In this case, a system integrator can purchase additional hardware and write software that will communicate with the host controller and provide analog signals to the ballast.

The Host controller may give commands to the ballast over the host machine digital network 140 to control the ballast output power, output current and output voltage. The ballast controller 120 will continuously monitor the commands and cause the lamp output 112 to reach whichever parameter (output power, output current, or output voltage) is encountered as an operating limit. Typically, the lamp is controlled with a power request and the lamp voltage and lamp current parameters are used to limit the operation under special situations such as starting or stopping the lamp.

### 2.2 Analog Input Signal

To maintain backward compatibility with other product lines or plant control systems, the electronic ballast control system 100 shown in FIG. 1 also has an analog input 136. The input may be scaled several different ways, for example as a 0V to 10V signal or a 4 mA to 20 mA signal. This signal can be used to control the output power level of the ballast 100. A DIP switch (not shown in the figure) can be used to select which interface (analog input 136, or the digital communications interface 134) will be used to control the ballast 100.

### 2.3 Electrical Isolation

In one example, the Host control system operates with circuit potentials that are within a few volts of earth ground. The electronic ballast 100 is connected to 480 Vac, which when rectified produces nodes at +325 Vdc and −325 Vdc compared to the earth ground. Most of the ballast control circuits operate connected to the negative side of the input rectifier, which is typically at a potential of −325 Vdc compared to earth ground. Signals passing to and from the ballast controller 120 must have sufficient electrical isolation for this environment. In one example, optical isolation can be used inside the ballast controller 120 for passing these signals through the digital communications interface 134. Other types of electrical isolation can also be used.

### 2.4 VC1 Sense.

The VC1 Sense input to the control system 120 is an analog input voltage, for example, which is proportional to the input voltage across capacitor C1 after being rectified. Analog-to-digital conversion is used to further process this signal inside the control system 120.

### 2.5. VC2 Sense.

The VC2 Sense input to the control system 120 is an analog input voltage, for example, which is proportional to the DC output voltage produced across output capacitor C2 that feeds the inverter 108. Analog-to-digital conversion is used to further process this signal inside the control system 120.

### 2.6 Inverter Current Sense

The Inv Cur Sense input to the control system 120 is an analog input, for example, which is proportional to the current in the inverter 108 across sense resistor RIS, while the inverter drives the lamp. In one example, this current is represented by the voltage VRIS developed across sense resistor RIS. Analog-to-digital conversion is used to further process this signal. The control system 120 can also include a circuit that multiplies the inverter current (output current) and the output dc-bus voltage (equal to the magnitude of the lamp square wave) to produce a signal for use in the controller that is proportional to the lamp output power.

### 2.7 Microcontroller Based Control System 120

In one example, the control system 120 includes two Programmable Intelligent Controllers (PIC microcontrollers) by Microchip Inc, which are used along with other supporting circuitry to implement the controller function for the ballast 100. Other types and brands of controllers could also be used. One microcontroller interfaces with the external inputs and is referenced to earth ground. Digital data is passed back and forth using opto-isolators. The second microcontroller is referenced to the power system ground (about 325 V negative compared to the earth ground). In addition to the microcontrollers, the control system includes various digital and analog components.

The control system 120 can include a computer-readable medium, such as a RAM and/or ROM memory, which stores software and/or firmware instructions, for example, that when executed perform the control and other functions described herein in response to commands received over the Host-Machine digital network 140 and various operating states of the ballast.

### 2.8 IRef

On one example, the control system 120 generates an analog output signal, IRef, which is produced using digital-to-analog conversion. The current in the converter 106 is sensed by measuring the voltage across the converter current sense resistor RCS. When the converter power switches Q1 and Q2 are on, the current IL1 in the converter inductor L1 will increase. IRef defines the upper limit for the converter inductor current on a cycle-by-cycle basis. Comparator 122 compares the upper limit defined by IRef with the actual converter current IL1, as sensed by sense resistor RCS. When the converter current IL1 reaches a value equal to IRef, comparator 122 resets flip-flop 124 to terminate the “on time” of converter transistors Q1 and Q2. The operation of set-reset flip-flop 124 and buffers 126 is described in more detail below.

### 2.9 Converter Drive Enable

The control system 120 generates an output signal, Con Drv Enbl, which enables the converter transistors Q1 and Q2 to operate if it is high. If it is low, the converter transistors are off. For simplicity, the gating of Con Drv Enbl with the transistors' gate control signals “Gate Q1” and “Gate Q2” is not shown in FIG. 1. This gating can be incorporated into the buffers 126 or at any other location can affect the transistor gate control signals.

### 2.10 Inverter Drive Enable

The control system 120 generates an output signal, Inv Drv Enbl, which enables the inverter transistors Q3-Q6 to operate if it is high. If it is low, the inverter transistors Q3-Q6 are off. Again, for simplicity, the gating of Inv Drv Enbl with the transistors' gate control signals “Gate Q3”, “Gate Q4”, “Gate Q5” and “Gate Q6” is not shown in FIG. 1. Again this gating can be incorporated into the buffers 132 or at any other location can affect the transistor gate control signals.

### 2.11 Clock fsw

The control system 120 generates a clock signal, Clock fSW, which defines the switching frequency of the converter 106. For example a 6 kHz clock may be used in a 15 kW converter. Each rising edge of the clock is used to turn on the converter transistors Q1 and Q2.

### 2.12 Divide by 64

In one example, control circuit 114 includes a variable frequency divider, such as a divide by 64 circuit 128, which includes a synchronous counter that produces a clock frequency that is 64 times slower than the converter switching clock. A divide by 64 circuit is a convenient circuit to implement with digital logic. The clock output from the divider is guaranteed to have a 50% duty ratio as long as the converter clock is running at a constant frequency. This clock is used to drive the inverter transistors Q3-Q6. It is easy to divide by a power of two with digital circuits, although dividing by any integer is possible with relatively simple circuits.

A switch setting, for example, can be provided on the control board to change the frequency divider to divide by 16 or 32 instead of 64, for example. There could be some reasons for wanting a particular frequency square wave at the lamp. One might be using a “400 Hz” transformer (which is an industry standard frequency) between the ballast and the lamp. This could be the case if a lamp is to be used that operates with a current or voltage that is not in the range of what the electronic ballast can produce.

In a further example, the switching frequency of the converter is set to just under 5 kHz and the frequency divider 128 is set to divide by 16 for a frequency at the lamp of 300 Hz. Alternatively, the frequency divider 128 can be set to divide by 64 for a frequency at the lamp of 75 Hz. Other examples also exist.

### 2.13 Toggle Flip Flop

The Toggle flip-flop 130 receives the divided clock signal produced by the divide by 64 frequency divider 128 and creates low frequency square wave control signals for an inverter gate drive circuit, represented by buffers 132, which drives the gates of transistors Q3-Q6.

### 2.14 Q1 and Q2 Drive (Peak Current Mode Control)

In the example shown in FIG. 1, the converter 106 operates with peak current mode control. The rising edge of the clock signal Clock fSW sets the Set-Reset flip-flop 124, which turns on power switches Q1 and Q2 simultaneously. The current IL1 in the inductor L1 will flow through Q1 and Q2. The voltage Vc1 is applied to the inductor L1 and the current will increase linearly as a function of time. When the current reaches the value so that the voltage produced by sensing the current is equal to (or slightly larger than) the voltage at the Iref output, the comparator 122 will detect this event and reset the S-R flip-flop 124. This turns off the power switches Q1 and Q2. The inductor current IL1 must continue to flow and will now flow through diodes D1 and D2, thereby transferring energy to the output filter capacitor C2.

To avoid instabilities in the process when the duty ratio for switches Q1 and Q2 is greater than 50%, a technique know as “slope compensation” can be used. This type of instability and the slope compensation is well reported in literature. A time varying signal (in our exemplary implementation) that is synchronous with the switching action is subtracted from the reference signal. So, as the switch is on longer, the threshold at which it turns off is reduced.

To avoid a false termination of the pulse, a technique known as leading edge blanking can be used. Noise is picked up on the current sense signal when switching occurs. The leading edge blanking is used to momentarily disable the comparator at the turn-on instant so any noise present will be ignored.

### 3. Lamp Interface Network 110

A gas discharge lamp is similar to a bidirectional Zener diode when it is conduction. Like a Zener diode, the current in a discharge lamp can vary over a wide range with very little change in operating voltage. The operating voltage is a strong function of temperature. When the lamp is cool, the operating voltage will be relatively low. The operating voltage will increase as the lamps warms up to the steady state operating temperature (which may be on the order of 700 C). When the lamp is conducting, if the current being delivered to the lamp is reversed rapidly; the lamp will go into conduction in the reverse direction and conduct at the same operating voltage magnitude.

If the lamp is not in conduction, it appears as an open circuit. There may be some parasitic inductance and capacitance from the wiring to the lamp and the lamp terminals, but these can be ignored.

If a lamp is not in conduction, a voltage must be applied across the terminal to “ignite” the lamp causing conduction. The high voltage gradient in the lamp causes the gas in the lamp to ionize which supports current flow. This change of state is similar to throwing a switch. The lamp goes from a high-impedance, non-conducting state to a very low-impedance constant-voltage conducting state almost instantly upon ignition

When the lamp is cold, the voltage level that must be applied to ignite the lamp is typically equal to or greater than the voltage at which the lamp would operate at a normal “hot” operating temperature. Some lamp ballasts have a separate active circuit to produce ignition, which adds cost and complexity. Other ballasts, such as the Gen 3 Ballast available from Nicollet Technologies of Minneapolis, Minn. USA, drive the lamp through a power inductor that can accommodate the sudden drop in lamp voltage upon ignition.

Thus to start the lamp, the electronic ballast 100 shown in FIG. 1 must be able to produce a high voltage across the open circuit of the lamp. This means for ignition, a high voltage must be present in the output capacitor C2 of the converter 106. But when the lamp ignites, the voltage rapidly falls to a very low level causing a very large current to flow out of C2 and flow through the pair of inverter switches that happen to be turned on at the ignition instant. Ignition is not necessarily synchronous with switching of the converter. This large current can cause failures of the transistors Q3-Q6 of the output inverter 108.

Reducing the size of C2 is one way to limit the size of the current spike that is created. However, C2 must be sufficiently large to handle the ripple currents produced by the converter both in terms of RMS ripple current rating and capacitance to control the ripple voltage that is produced. There is another design constraint that is also placed on value of C2, which is the necessity to capture the energy in the inductor L1 if the lamp goes out. If the lamp goes out, there will be a delay in detecting this and a delay in a response by the control circuit 114. The inductor current IL1 will be dumped into the output capacitor C2 causing a voltage increase. The amount of voltage increase depends on the value of C2 as well as the delay times and value of L1. If the voltage increase is too large, the transistors of the converter 106 or the inverter 108 could fail.

To address these issues in the circuit shown in FIG. 1, the output of the inverter 108 is coupled to the lamp output through a lamp interface network 110. FIG. 3 illustrates the lamp interface network 110 in greater detail.

The lamp interface network 110 includes an RLC circuit having a first inductor-resistor leg connected to node N1, a second inductor-resistor leg connected to node N2 and a capacitor C0 connected across the lamp outputs 112. In this example, inductors L₂ and L₃ have substantially equal inductances of L0/2, resistors R₁ and R₃ have substantially equal resistances of R0/2, and capacitor C₀ has a capacitance of C0.

During ignition, the lamp interface network circuit 110 can have the following properties:
The circuit limits the current during lamp ignition, thus preventing transistor failures; and/or
The circuit produces a voltage doubling effect at the lamp causing the lamp to start at lower voltage levels at the output capacitor C₂.

During normal operation:
The circuit limits the rise/fall times of the output signal, which is useful for limiting electromagnetic interference (EMI);
The circuit produces a voltage doubling effect for automatic re-strike and to operate at lower lamp powers; and/or
The circuit does not significantly alter the benefits of the square wave operation (the constant UV output).

Additional benefits of the circuit can include:
No special drive or control circuits are needed; and/or
The components are relatively small.

The control system 120 has a start up routine, which first turns on the output inverter 108. Initially the output of the converter 106 is at zero volts. The converter 106 is turned on with a command to produce a charging current of a selected magnitude. This causes the voltage VC2 on the output capacitor C2 to increase. At each edge of the square wave produced by the inverter 108, the lamp interface circuit 110 goes though a resonant cycle. Because the resistance R in the lamp interface circuit 110 has a fairly small value, the circuit is significantly under-damped. The capacitor C₀ is in parallel with the lamp and thus the capacitor voltage is identical to the lamp voltage. When a voltage step is applied to the lamp interface circuit 110, the voltage across the capacitor will ring to a value that is typically twice of the amplitude of the step at a frequency that is approximately the self-resonant frequency of the LC network. This frequency is in the order of 100 s of kilohertz. The resistor will act to dampen the oscillation. After a number resonant cycles, the voltage across the capacitor C₀ will settle down and be equal to the voltage at the output of the converter 106.

If the lamp ignites, the voltage across the lamp will drop to a very low value, which is typically much less than the voltage level on the output capacitor C₂ of the converter 106. The voltage difference then appears across the switches Q3-Q6 of the inverter 108, and the resistors and the inductors of the lamp interface circuit 110. Initially, the inductors of the lamp interface circuit 110 will limit the rate of rise of the current delivered to the lamp. As the current increases, the voltage drop across the resistors will also increase, which will limit the current. Each of the resistors could include conventional devices that have a nearly constant resistance or could include devices with a negative temperature coefficient (NTC), which is typically used to limit current surges.

After the lamp starts, the lamp becomes a low impedance. Although at each transition of the output square wave, the lamp must be re-ignited with current in the opposite direction.

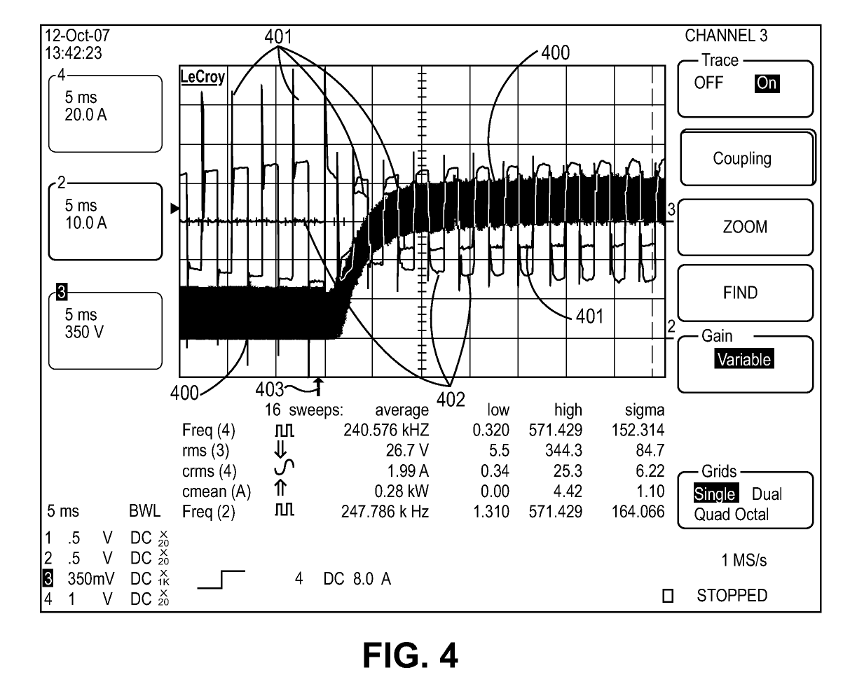

FIG. 4 illustrates a screen display from an oscilloscope showing waveforms on a scale of 5 mS per division that are produced by the circuit shown in FIGS. 1 and 3 when igniting a 10 kW lamp. Channel 2 (reference numeral 400) represents the current through inductor L1. Channel 3 (reference numeral 401) represents the output voltage VC2 produced across output capacitor C2. Channel 4 (402) represents the lamp current.

Initially the inductor current 400 is switching between zero and 12 Amps to produce a current that charges the output capacitor C2 of the converter 106. The charging of the output capacitor C2 of the converter 106 can be seen in the increasing amplitude of the output voltage 401 of the inverter 108 before the trigger point. During this time the lamp current 402 is zero. On this scale, the voltage doubling effect of the lamp interface circuit 110 just appears as a narrow spike in the waveform 401. The lamp starts at the trigger arrow (arrow 403 below the grid) as the oscilloscope was triggered by lamp current. After starting, the control circuit 114 senses that the lamp has started and the inductor current 400 is increased to reach either the current limit or the power limit.

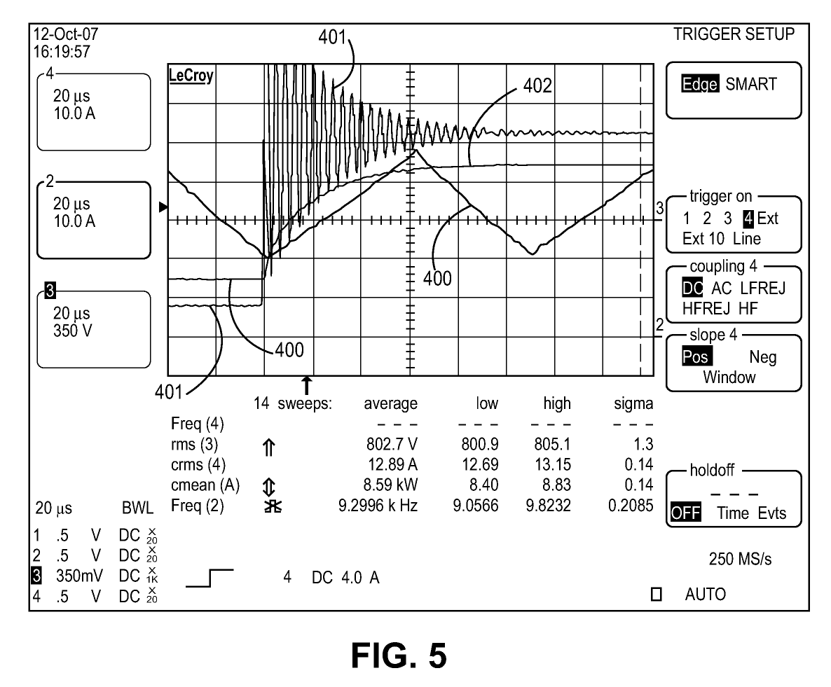

FIG. 5 shows the same waveforms on a time scale 20 uS per division when the lamp is running during normal operation in which the output voltage VC2 (401) switches with a generally square wave output waveform.

Referring back to FIG. 3, other lamp interface network configurations can be used in alternative embodiments. For example, an inductor and resistor may be provided on only one of the network legs rather than both legs. For example, inductor L₂ and resistor R₁ could be removed, or inductor L₃ and resistor R₃ could be removed, and the respective node N1 or N2 could be connected directly to the respective lamp output terminal 112. In a further example, the inductors and resistors in one of the two legs of the network 110 can have different a different inductance and/or a different resistance from those in the other leg of the network. In a further example, both resistors could be eliminated so that the network is an LC network.

In one example, the same function as that provided in FIG. 3 is provided with a single inductor (having an inductance equal to L2+L3=L0) and a single resistor (having a resistance of R1+R3=R0) (or thermistor). This would be a simpler circuit having only one inductor, one capacitor and one resistor. The arrangement shown in FIG. 3 is used in one example because it is a symmetric arrangement that tends to reduce the EMI that might be created in the circuit. Other versions of this arrangement are possible, which use series and parallel combinations of parts. But, in essence the lamp interface network 110 connects a series RLC circuit to the output of the ballast 100. The lamp load is connected in parallel with the capacitor.

Although the present disclosure has been described with reference to one or more examples, workers skilled in the art will recognize that changes may be made in form and detail without departing from the scope of the disclosure and/or the appended claims.

What is claimed is:

1. A circuit comprising:
an electronic ballast having an AC output with first and second output nodes;
first and second lamp outputs for connection to a gas discharge lamp; and
a lamp interface network comprising an inductance-capacitance (LC) circuit coupled between at least one of the first and second output nodes and a respective one of the first and second lamp outputs.

2. The circuit of claim 1, wherein the LC circuit comprises:
a first inductor in a first leg between the first output node and the first lamp output; and
a capacitor coupled between the first and second lamp outputs.

3. The circuit of claim 2, wherein the LC circuit further comprises:
a second inductor in a second leg between the second output node and the second lamp output.

4. The circuit of claim 3, wherein the first and second inductors have the same inductance.

5. The circuit of claim 1, wherein the LC circuit comprises a resistance-inductance-capacitance (RLC) circuit.

6. The circuit of claim 1, wherein the LC circuit comprises:
a first inductor and a first resistor coupled in series with one another in a first leg between the first output node and the first lamp output; and
a capacitor coupled between the first and second lamp outputs.

7. The circuit of claim 6, wherein the LC circuit further comprises:
a second inductor and a second resistor coupled in series with one another in a second leg between the second output node and the second lamp output.

8. The circuit of claim 7, wherein:
the first and second inductors have the same inductance; and
the first and second resistors have the same resistance.

9. The circuit of claim 1, wherein the electronic ballast comprises:
a DC-to-DC converter having a controlled DC output; and
an inverter coupled to the controlled DC output and having an AC output coupled to the first and second output nodes.

10. The circuit of claim 9, and further comprising:
a utility input for receiving an AC line voltage from a utility; and
a rectifier coupled between the utility input and the DC-to-DC converter.

11. The circuit of claim 1 and further comprising a gas discharge lamp coupled between the first and second lamp outputs.

12. A circuit comprising:
a ballast having an AC output with first and second output nodes;
first and second lamp outputs for connection to a gas discharge lamp; and
a lamp interface network comprising:
a first inductor and a first resistor coupled in series with one another in a first leg between the first output node and the first lamp output;
a second inductor and a second resistor coupled in series with one another in a second leg between the second output node and the second lamp output; and
a capacitor coupled between the first and second lamp outputs.

13. The circuit of claim 12, wherein:
the first and second inductors have the same inductance; and
the first and second resistors have the same resistance.

14. The circuit of claim 12, wherein the electronic ballast comprises:
a DC-to-DC converter having a controlled DC output; and
an inverter coupled to the controlled DC output and having an AC output coupled to the first and second output nodes.

15. The circuit of claim 14, and further comprising:
a utility input for receiving an AC line voltage from a utility; and
a rectifier coupled between the utility input and the DC-to-DC converter.

16. A method comprising:
generating, with a ballast, an alternating-current (AC) output voltage on first and second output nodes; and
coupling the AC output to first and second gas discharge lamp outputs through an inductance-capacitance (LC) circuit and thereby limiting a rate of change of current on the first and second gas discharge lamp outputs.

17. The method of claim 16 wherein the step of coupling comprises coupling the AC output to first and second gas discharge lamp outputs through an LC circuit that comprises:
a first inductor in a first leg between the first output node and the first lamp output; and
a capacitor coupled between the first and second lamp outputs.

18. The method of claim 17 wherein the step of coupling comprises coupling the AC output to first and second gas discharge lamp outputs through an LC circuit that further comprises:
a second inductor in a second leg between the second output node and the second lamp output.

19. The method of claim 18, wherein the first and second inductors have the same inductance.

20. The method of claim 16 wherein the step of coupling comprises coupling the AC output to first and second gas discharge lamp outputs through an RLC circuit that comprises:
a first inductor and a first resistor coupled in series with one another in a first leg between the first output node and the first lamp output;
a second inductor and a second resistor coupled in series with one another in a second leg between the second output node and the second lamp output; and
a capacitor coupled between the first and second lamp outputs.
